(19) United States
(12) Patent Application Publication
(10) Pub. No.: US 2005/0178311 A1
(43) Pub. Date: Aug. 18, 2005

(54) Sea anchor apparatus

(76) Inventor: Katherine Wittig, Kaleva, MI (US)

Correspondence Address: King & Jovanovic, PLC, 170 College Avenue, SUITE 230, HOLLAND, MI, 49423, US

(21) Appl. No.: 11/056,924

(22) Filed: Feb. 11, 2005

Related U.S. Application Data
(60) Provisional application No. 60/544,011, filed on Feb. 12, 2004.

(51) Int. Cl. F16L 27/00; B63B 21/48

(52) U.S. Cl. 114/311

(57) ABSTRACT

A sea anchor comprising a frame, a body and an attachment member. The frame includes a base ring and an opposing ring spaced apart therefrom, and a plurality of ribs extending between the base ring and the opposing ring, and a plurality of lead lines extending from the base ring away from the opposing ring. The body comprising a covering that extends between the opposing ring and the base ring. The attachment member is attached to the lead lines and facilitates attachment of the sea anchor to an outside boat line.

### CROSS-REFERENCE TO RELATED APPLICATION

This application claims the benefit of U.S. Provisional Patent Application Ser. No. 60/544,011 filed Feb. 12, 2004 the entire specification of which is hereby incorporated by reference.

### BACKGROUND OF THE INVENTION

1. Field of the Invention

The present invention relates in general to sea anchor, and more particularly to a sea anchor which is capable of being used with boats of various sizes.

2. Background Art

Sea anchors have been in use for a number of decades to facilitate and control the movement of a boat. While such anchors have been in use, the designs have suffered from many drawbacks. For example, many of the constructions are exceedingly cumbersome and not capable of collapsing for stowage. Other sea anchors have been stowable, but the durability of these sea anchors is such that they would tear or rip shortly after being employed. As such, users need to be equipped with many sea anchors as replacements. Still other sea anchors have been difficult and/or costly to construct, thereby lessening acceptability.

Thus, it is an object of the present invention to overcome the deficiencies of the prior art.

This and other objects will become apparent in light of the specification and claims appended hereto.

### SUMMARY OF THE INVENTION

The invention is directed to a sea anchor comprising a frame, a body and an attachment member. The frame comprises a base ring, an opposing ring, a plurality of ribs and a plurality of lead lines. The opposing ring is spaced apart from the base ring. The plurality of ribs extend between the base ring and the opposing ring. The plurality of lead lines extend from the base ring in a direction generally opposite to the opposing ring. The body comprises a covering attached at the one end to the base ring and at the other end to the opposing ring. The attachment member is attached to the lead lines.

In a preferred embodiment, each of the plurality of ribs is integrally formed with at least one of the plurality of lead lines.

In another preferred embodiment, the plurality of ribs are positioned about each of the base ring and the opposing ring in a spaced apart orientation wherein the radial spacing between the adjacent ribs is substantially equal.

In another preferred embodiment, the plurality of ribs are spaced apart from each other a radial distance of approximately 90°.

In another preferred embodiment, the base ring and the opposing ring comprise a circular configuration spaced apart in a substantially parallel orientation.

In a preferred embodiment, the base ring, the opposing ring and the plurality of ribs comprise a woven nylon webbing.

Preferably, each of the base ring and the opposing ring are stitched to the body substantially about an entire circumference thereof.

In one such embodiment, each of the plurality of ribs are stitched to the body substantially about an entire length thereof.

In a preferred embodiment, each of the plurality of lead lines are stitched to the base ring, and each of the plurality of ribs are stitched to each of the base ring and the opposing rings.

Preferably, each of the plurality of lead lines are attached to the attachment assembly.

In a preferred embodiment, pairs of the plurality of lead lines are integrally formed.

In another preferred embodiment, the attachment assembly comprises a D-ring attached to each of the plurality of lead lines.

In another embodiment, the sea anchor further comprises a retrieval member extending from the opposing ring.

In a preferred embodiment, the retrieval member is integrally associated with at least one of the lead lines.

In another aspect of the invention, the invention comprises a sea anchor. The sea anchor comprises a frame, a body and an attachment member. The frame comprises a base ring, an opposing ring, at least three spaced apart ribs, a plurality of lead lines and a retrieval member. The opposing ring is spaced apart from the base ring. The at least three spaced apart ribs extend between the base ring and the opposing ring. The at least three spaced apart ribs being radially spaced apart substantially equidistantly about each of the opposing ring and the base ring. The plurality of lead lines extend from the base ring in a direction generally opposite to the opposing ring, wherein a lead line extends from the base ring proximate each one of the at least three spaced apart ribs. The retrieval member extends from the opposing ring. The retrieval member comprising a loop. The body comprises a covering attached at the one end to the base ring and at the other end to the opposing ring, wherein each of the at least three spaced apart ribs are attached to the body. The attachment member is attached to the lead lines.

In a preferred embodiment, the frame comprises a nylon webbing.

In another preferred embodiment, the base ring and the opposing ring are generally substantially parallel to each other.

In another preferred embodiment, the retrieval member is integral with one of the at least three spaced apart ribs.

In yet another preferred embodiment, each of the opposing ring, the base ring and the at least three spaced apart ribs are stitched to the body about substantially the entire length thereof.

In another preferred embodiment the plurality of lead lines comprises four lead lines, defining opposing pairs of lead lines, wherein the opposing pairs are spaced apart from each other a distance greater than the distance between the lead lines of the respective pair, to, in turn, enhance the resistance to rotation of the sea anchor.

In another embodiment, the diameter of the base ring is at least 1.5 times the diameter of the opposing ring.

### BRIEF DESCRIPTION OF THE DRAWINGS

The invention will now be described with reference to the drawings wherein:

FIG. 1 of the drawings is side elevational view of the sea anchor of the present invention;

FIG. 2 of the drawings is a front plan view of the sea anchor of the present invention;

FIG. 3 of the drawings is a top plan view of a boat utilizing a plurality of sea anchors of the present invention; and

FIG. 4 of the drawings is a side elevational view of a sea anchor in a hanging orientation.

### DETAILED DESCRIPTION OF THE INVENTION

While this invention is susceptible of embodiment in many different forms, there is shown in the drawings several specific embodiments with the understanding that the present disclosure is to be considered as an exemplification of the principles of the invention and is not intended to limit the invention to the embodiments illustrated.

It will be understood that like or analogous elements and/or components, referred to herein, are identified throughout the drawings by like reference characters. In addition, it will be understood that the drawings are merely representations of the present invention, and some of the components may have been distorted from actual scale for purposes of pictorial clarity.

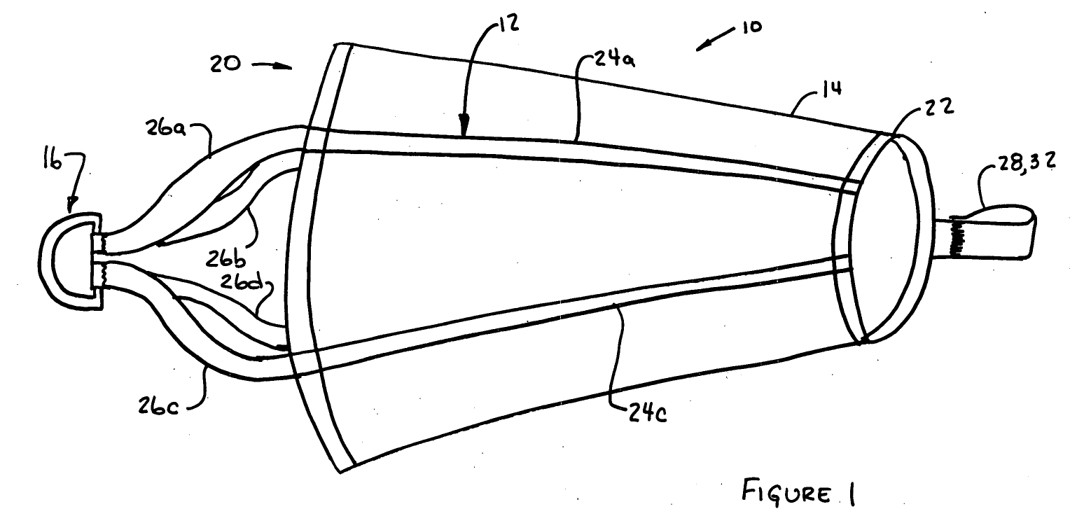

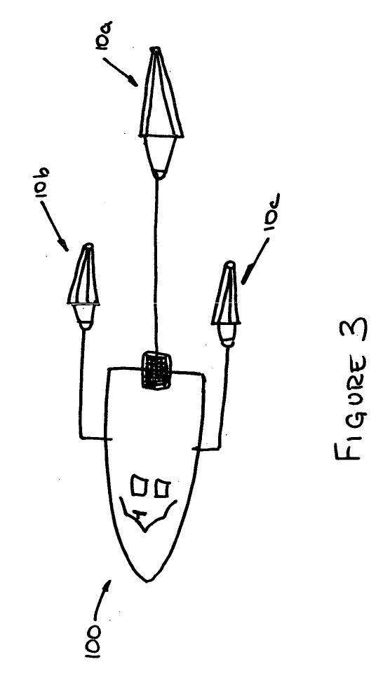

Referring now to the Figures, and in particular to FIG. 1, sea anchor 10 is shown as comprising frame 12, body 14 and attachment assembly 16. As is shown in FIG. 3, the sea anchor is configured for use in association with boat 100. In certain examples, the sea anchor can be positioned behind the boat (as with sea anchor 10a). In other embodiments opposing sea anchors 10b, 10c may flank either side of the boat (i.e., for balance when used with larger crafts). Indeed, the invention is not limited to any particular orientation and position of the sea anchor relative to a boat.

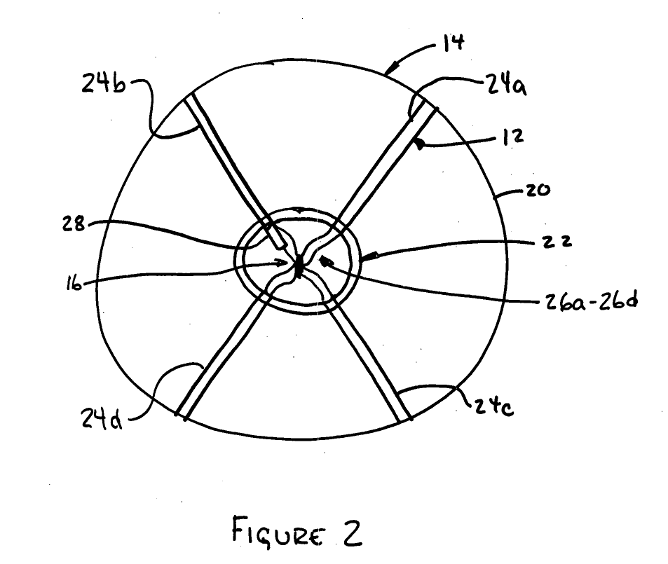

Referring again to FIG. 1, frame 12 includes base ring 20, opposing ring 22, a plurality of ribs 24a-24d (24b and 24d are shown in FIG. 2), a plurality of lead lines 26a-26d and retrieval member 28. Preferably, each component is stitched at an interface between components, so as to provide rigidity and enhanced durability. In the embodiment shown, the base ring and the opposing ring are separated a predetermined distance from each other, in a substantially parallel orientation. The opposing ring is generally substantially smaller than base ring 20 so as to define a substantially conical shape therebetween. Preferably, the diameter of the base ring is 1.5 times the diameter of the opposing ring. Of course, it is not limited thereto. The two rings are positioned such that they are substantially parallel (i.e., the central axis defined by each of the circles are collinear).

Ribs 24a-24d are spaced about each of the rings and extend from the base ring to the opposing ring. Generally, the ribs are spaced apart from each other every 90° about each of the rings. It is contemplated that a greater or fewer number of ribs may be utilized, and that a different angular spacing be used between the ribs. In one embodiment, three spaced apart ribs are contemplated for use. Indeed, in certain embodiments, it may be desirable to position pairs of ribs in close proximity to each other, and, increase the radial distance between the pairs. In such an embodiment, the sea anchor will tend to orient itself during use.

Lead lines 26a-26d are shown in FIG. 1 as extending away from base ring 20 in a direction opposite of opposing ring 22. The lead lines 26a-26d are used to provide an attachment member to which to attach the sea anchor (i.e., to facilitate the proper orientation of the sea anchor). Advantageously, in the embodiment shown, the ribs and the lead lines are integrated and comprise a single member. Such a configuration enhances the strength of the sea anchor. Of course, it is contemplated that the lead lines and the ribs are attached to each other at the base ring. In other embodiments, the lead lines and the ribs may be spaced apart from each other about the base ring.

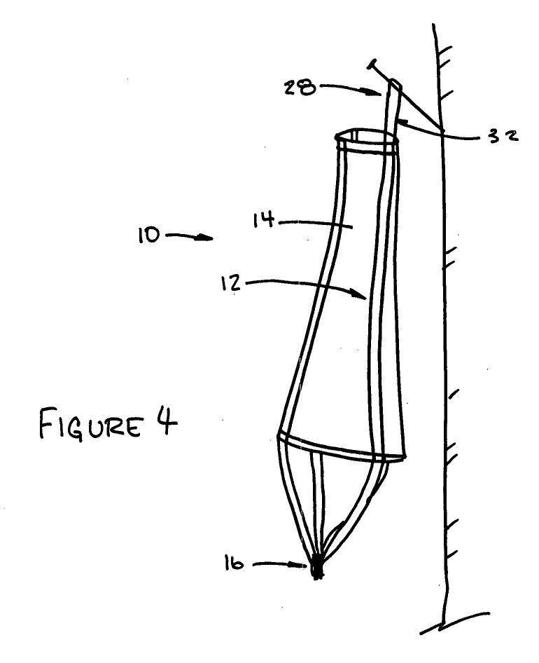

Retrieval member 28 is shown in FIGS. 1 and 4 as comprising loop 32 which extends beyond opposing ring 22. The loop 32 is preferably integrated with one of the rib members and attached about opposing ring 22. Such a placement and configuration provides a means by which grasp the device at the far end thereof for removal from the water. Additionally, the retrieval member may be used to hang the device so that it may dry, and also when it is not in use. Advantageously, inasmuch as it is preferably integrated with the remaining respective rib member, the durability as well as the construction cost can be optimized.

It is contemplated that each of the frame members comprise a nylon webbing having a width of approximately 1 inch. Of course other materials are contemplated, however it has been found that such a material exhibits good strength and durability characteristics. Additionally, where necessary, multiple frame members are attached to each other by way of nylon thread, which likewise exhibits good strength and durability characteristics.

Body 14 is shown in FIG. 1 as comprising a covering that is supported by frame 12. The covering extends between the base ring and the opposing ring and between the ribs extending from one ring to the other. Indeed, the covering is attached to each of the ring 20, the opposing ring 22, and the ribs 24a-d, by way of, for example nylon stitching. The covering may comprise a single piece of material cut to the desired shape or a plurality of panels that are joined by the frame members. Furthermore, the covering may include a number of openings to adjust the properties of the sea anchor. It is contemplated that the covering comprise a cordura (1,000 denier) material, while other materials are contemplated. Preferably, the frame is stitched to the body along the entire length of each of the components and the body.

Attachment member 16 is shown in FIG. 1 as comprising a “D” type ring which is coupled to the lead lines. In the embodiment shown, the lead lines 26a, 26b and ribs 24a, 24b comprise a single length of material. Similarly, the lead lines 26c, 26d and ribs 24c, 24d comprise a single length of material. The attachment member is positioned where the respective lead lines meet and the lead lines are stitched to each other to define a channel within which the ring is positioned.

The dimensions of each of the components can be varied depending on the size of the boat and the number of sea anchors that are to be utilized.

In operation, the sea anchor is attached to a boat line through attachment with the “D” type ring. Once attached to the boat line, the sea anchor is dropped into the water. Due to the configuration of the sea anchor, the sea anchor will act as a drag to the boat, to permit the boat to troll at a slow speed, or to drift during fishing.

The foregoing description merely explains and illustrates the invention and the invention is not limited thereto except insofar as the appended claims are so limited, as those skilled in the art who have the disclosure before them will be able to make modifications without departing the scope of the invention.

1. A sea anchor comprising:
a frame comprising
a base ring;
an opposing ring spaced apart from the base ring;
a plurality of ribs extending between the base ring and the opposing ring; and
a plurality of lead lines extending from the base ring in a direction generally opposite to the opposing ring;
a body comprising a covering attached at the one end to the base ring and at the other end to the opposing ring; and
an attachment member attached to the lead lines.

2. The sea anchor of claim 1 wherein each of the plurality of ribs is integrally formed with at least one of the plurality of lead lines.

3. The sea anchor of claim 1 wherein the plurality of ribs are positioned about each of the base ring and the opposing ring in a spaced apart orientation wherein the radial spacing between the adjacent ribs is substantially equal.

4. The sea anchor of claim 3 wherein the plurality of ribs are spaced apart from each other a radial distance of 90°.

5. The sea anchor of claim 1 wherein the base ring and the opposing ring comprise a circular configuration spaced apart in a substantially parallel orientation.

6. The sea anchor of claim 1 wherein the base ring, the opposing ring and the plurality of ribs comprise a woven nylon webbing.

7. The sea anchor of claim 1 wherein each of the base ring and the opposing ring are stitched to the body substantially about an entire circumference thereof.

8. The sea anchor of claim 7 wherein each of the plurality of ribs are stitched to the body substantially about an entire length thereof.

9. The sea anchor of claim 1 wherein each of the plurality of lead lines are stitched to the base ring, and each of the plurality of ribs are stitched to each of the base ring and the opposing ring.

10. The sea anchor of claim 1 wherein each of the plurality of lead lines are attached to the attachment assembly.

11. The sea anchor of claim 1 wherein pairs of the plurality of lead lines are integrally formed.

12. The sea anchor of claim 1 wherein the attachment assembly comprises a D-ring attached to each of the plurality of lead lines.

13. The sea anchor of claim 1 further comprising a retrieval member extending from the opposing ring.

14. The sea anchor of claim 1 wherein the retrieval member is integrally associated with at least one of the lead lines.

15. A sea anchor comprising:
a frame comprising
a base ring;
an opposing ring spaced apart from the base ring;
at least three spaced apart ribs extending between the base ring and the opposing ring, the at least three spaced apart ribs being radially spaced apart substantially equidistantly about each of the opposing ring and the base ring;
a plurality of lead lines extending from the base ring in a direction generally opposite to the opposing ring, wherein a lead line extends from the base ring proximate each one of the at least three spaced apart ribs; and
a retrieval member extending from the opposing ring, the retrieval member comprising a loop;
a body comprising a covering attached at the one end to the base ring and at the other end to the opposing ring, wherein each of the at least three spaced apart ribs are attached to the body; and
an attachment member attached to the lead lines.

16. The sea anchor of claim 15 wherein the frame comprises a nylon webbing.

17. The sea anchor of claim 15 wherein the base ring and the opposing ring are generally substantially parallel to each other.

18. The sea anchor of claim 15 wherein the plurality of lead lines comprises four lead lines, defining opposing pairs of lead lines, wherein the opposing pairs are spaced apart from each other a distance greater than the distance between the lead lines of the respective pair, to, in turn, enhance the resistance to rotation of the sea anchor.

19. The sea anchor of claim 15 wherein each of the opposing ring, the base ring and the at least three spaced apart ribs are stitched to the body about substantially the entire length thereof.

20. The sea anchor of claim 19 wherein the diameter of the base ring is at least 1.5 times the diameter of the opposing ring.
